(19) United States
(12) Patent Application Publication
(10) Pub. No.: US 2014/0079067 A1
(43) Pub. Date: Mar. 20, 2014

(54) INFORMATION CENTRIC NETWORK (ICN) NODE BASED ON SWITCH AND NETWORK PROCESS USING THE NODE

(71) Applicant: Electronics and Telecommunications Research Institute, Daejeon (KR)

(72) Inventors: Hong Seok JEON, Daejeon (KR); Byung Joon LEE, Daejeon (KR); Seung Hyun YOON, Daejeon (KR)

(73) Assignee: Electronics and Telecommunications Research Institute, Daejeon (KR)

(21) Appl. No.: 14/025,154

(22) Filed: Sep. 12, 2013

(30) Foreign Application Priority Data
Sep. 14, 2012 (KR) 10-2012-0102365
Jul. 12, 2013 (KR) 10-2013-0081934

(51) Int. Cl. H04L 12/741

(52) U.S. Cl. CPC H04L 45/74
USPC 370/392

(57) ABSTRACT

The present invention relates to an apparatus for supporting information centric networking. An information centric network (ICN) node based on a switch according to the present invention includes an ICN process configured to request information for providing content desired by a user or process an ICN protocol for responding to the requested information; a line card configured to transfer a received packet to the ICN process by recognizing a header format of the packet and, or output the received packet by determining an output port; and a switch module configured to relay a transfer of the packet between the line cards.

### CROSS-REFERENCE TO RELATED APPLICATIONS

This application claims priority to and the benefit of Korean Patent Application No. 10-2012-00102365 filed in the Korean Intellectual Property Office on Sep. 14, 2012, and No 10-2013-0081934 filed in the Korean Intellectual Property Office on Jul. 12, 2013, the entire contents of which are incorporated herein by reference.

### TECHNICAL FIELD

The present invention relates to an apparatus for supporting an information centric network (ICN).

### BACKGROUND ART

An information centric network (ICN) is an attempt to reorganize an existing Internet communication paradigm for performing end-to-end communication, in order to be information centric. In the ICN, instead of performing predetermined operations for finding an address of a host maintaining information, accessing the corresponding host, and fetching information, a user simply provides, to a network, an identifier of the information desired to be obtained. The network finds the information using the identifier and provides the information to the user.

Representative research projects about the ICN are a data-oriented network architecture (DONA) and a content centric network (CCN).

The DONA refers to a research project that has proceeded based on Teemu Koponen of UC Berkeley, and defines an ICN that uses an information identifier based on a public key. The DONA proposes a communication model based on a hierarchical network structure configured as a resolution handler (RH). The RH manages routing information for transferring an information request packet to an appropriate neighbor RH when the information request packet is received. In the DONA, an information holder generates a REGISTER packet and transmits the REGISTER packet to an adjacent RH in order to register maintaining information to a DONA network. The RH manages routing information based on the REGISTER packet. An information requestor generates a FIND packet including an identifier of requesting information and transmits the FIND packet to an adjacent RH. The RH transfers the FIND packet to a neighbor RH based on the routing information so that the FIND packet is transmitted to the information holder or a predetermined node caching the information.

The CCN that is a research project based on Van Jacobson of progress aircraft repair cycle (PARC) research institute uses an information identifier of a hierarchical structure. The information identifier of the CCN is similar to a universal resource locator (URL) in an aspect that the information identifier of the CCN is hierarchically configured, but is different from the URL in an aspect that address information is not included. The CCN uses a communication model in a request-response form. An entity requesting information generates an INTEREST packet that is a request message and transmits the INTEREST packet to a network. The network that receives the INTEREST packet transmits the INTEREST packet to a holder of corresponding information. When the INTEREST packet is received, an information holder generates a DATA packet as a response message and transmits the DATA packet. The DATA packet is transmitted again to the entity having requested the information through the CCN.

### SUMMARY OF THE INVENTION

The present invention has been made in an effort to provide a method for realizing an information centric network (ICN) based on switch equipment. More particularly, the present invention is to configure key functions of an ICN finding and obtaining information within a switch by operating an ICN process to operate within switch equipment and thereby support an ICN protocol.

An exemplary embodiment of the present invention provides an ICN node based on a switch, including: an ICN process configured to process an ICN protocol that is a transmission standard about a predetermined operation of transmitting and receiving information desired by a user; a line card configured to transfer the received packet to the ICN process, recognize a header format of the packet, determine an output port, and thereby output the packet; and a switch module configured to relay transfer of the packet between line cards.

Another exemplary embodiment of the present invention provides an method for an ICN process based on a switch, the method including: receiving an ICN information request packet transmitted from a line card in order to request information and an ICN information response packet transmitted as a response to the ICN information request packet; transferring the received packet to the ICN process, and interpreting, by the ICN process, and verifying the transferred packet; and processing, by the ICN process, the verified packet.

According to a configuration of the present invention, information centric networking may be achieved based on switch equipment. According to the present invention, key functions of information centric networking for finding and obtaining information within the switch equipment may be configured within a switch.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating a structure of an information centric network (ICN) according to an exemplary embodiment of the present invention.

FIG. 2 is a diagram illustrating an ICN node configured based on a switch according to an exemplary embodiment of the present invention.

FIG. 3 is a block diagram illustrating an internal structure of an ICN node based on a switch according to an exemplary embodiment of the present invention.

FIGS. 4 and 5 are diagrams illustrating a case in which an ICN node based on a switch directly provides content requested by a user.

FIG. 6 is a diagram illustrating a case in which an ICN node based on a switch transmits an ICN information request packet according to an exemplary embodiment of the present invention.

FIG. 7 is a diagram illustrating a case in which an ICN node based on a switch receives and relays an ICN information request packet and an ICN information response packet according to an exemplary embodiment of the present invention.

FIG. 8 is a diagram illustrating a case in which an ICN node based on a switch receives an ICN information response packet as a response to an ICN information request packet generated and initially transmitted by the ICN node according to an exemplary embodiment of the present invention.

FIG. 9 is a diagram illustrating a case in which an ICN node based on a switch receives an ICN information request packet according to an exemplary embodiment of the present invention.

FIG. 10 is a flowchart illustrating an ICN process based on a switch according to an exemplary embodiment of the present invention.

FIG. 11 is a flowchart illustrating in detail an ICN process based on a switch according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

The following description simply exemplifies a principle of the invention. Accordingly, even though not clearly described or illustrated in the present specification, those skilled in the art may configure the principle of the invention and may invent a variety of apparatuses included in the concept and scope of the invention. In addition, all of the conditional terminologies and exemplary embodiments enumerated in the present specification are clearly intended only for the purpose of understanding the concept of the invention, in principle. Accordingly, the invention should not be understood to be limited to the exemplary embodiments and states particularly enumerated as above.

The aforementioned objects, features, and advantages will become further obvious through the following detailed description which is associated with the accompanying drawings and accordingly, those skilled in the art may easily implement the technical spirit of the invention. Further, when it is determined that the detailed description related to a related known function or configuration may make the purpose of the present invention unnecessarily ambiguous in describing the invention, the detailed description will be omitted herein. Hereinafter, exemplary embodiments of the present invention will be described in detail with reference to the accompanying drawings.

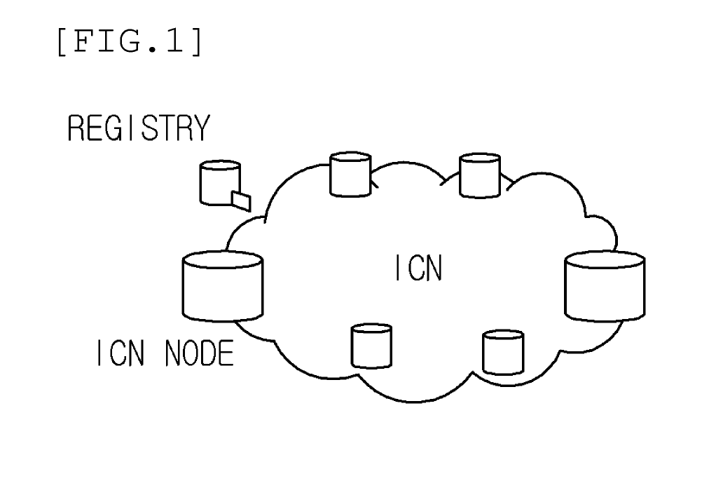

FIG. 1 is a diagram illustrating a structure of an information centric network (ICN) according to an exemplary embodiment of the present invention. The ICN assumed in the present invention includes an ICN node and a registry. The ICN node is network equipment that serves to store, request, and transmit information. The registry is equipment that serves to record and manage an ICN node that stores corresponding information. The registry is also an ICN node, but additionally includes a capability of managing a list of <identifier of information, position information of an ICN node to store information corresponding to the identifier>. In the present invention, information is a general terminology that includes content.

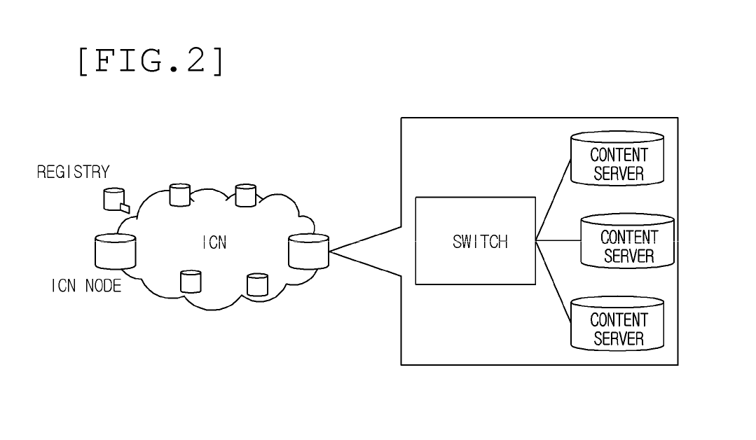

FIG. 2 is a diagram illustrating an ICN node configured based on a switch according to an exemplary embodiment of the present invention. As illustrated in FIG. 2, the ICN node based on the switch is provided in a structure in which a plurality of content servers is connected based on the switch. The switch includes an Ethernet switch and a multilayer switch. A content server refers to a server to provide an information service to a user including a media streaming server and a file server. Therefore, according to an increase in the service use or every time a service type is added, a service server corresponding to the switch is added, thereby providing a scalable structure of increasing a processing capability.

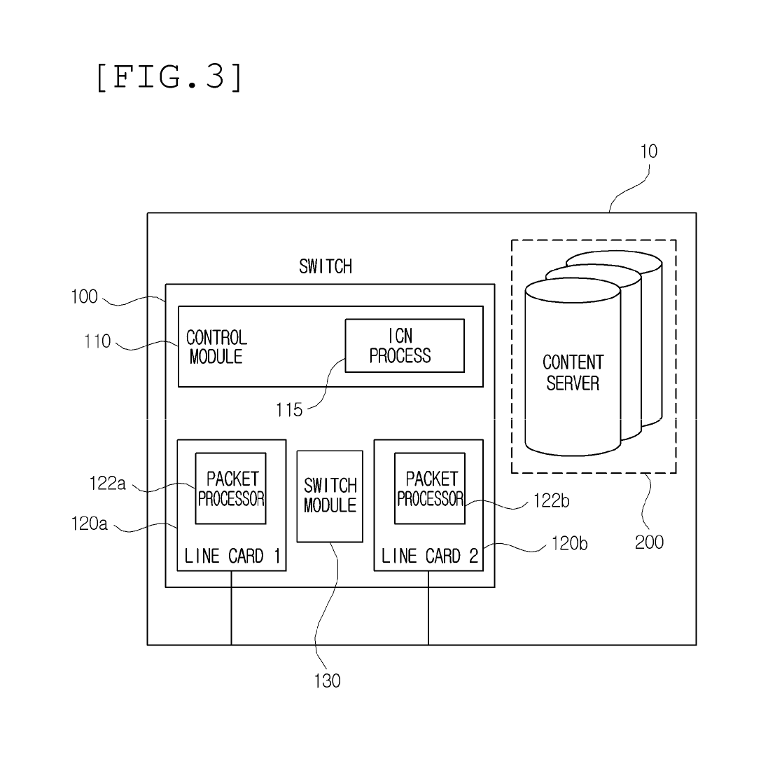

FIG. 3 is a block diagram illustrating an internal structure of an ICN node 10 based on a switch 100 according to an exemplary embodiment of the present invention. Referring to FIG. 3, the ICN node 10 based on the switch 100 has an internal structure of a general Ethernet switch or a multilayer switch as a basic structure, and additionally includes an ICN process 115 that is a separate process for supporting an ICN protocol.

In the present exemplary embodiment, the ICN process 115 processes an ICN protocol that requests information in order to provide information desired by a user, finds the requested information, and responds using the found information.

Line cards 120a and 120b transfer a received packet to the ICN process 115 by recognizing a header format of the received packet, or output the received packet by determining an output port.

A switch module 130 relays a transfer of the packet between the line cards 120a and 120b.

The internal structure of the switch 100 such as the general Ethernet switch or the multilayer switch includes a control module 110, the line cards 120a and 120b, and the switch module 130. The control module 110 corresponds to a brain of controlling and managing the entire switch system, and various types of protocols are loaded to the control module 110. The line cards 120a and 120b are key portions of processing a packet and serve to recognize and thereby process a header of the received packet based on packet processors 122a and 122b. The switch module 130 serves as a bridge to transfer a packet between the line cards 120a and 120b.

FIG. 3 illustrates an example in which the ICN process 115 for processing the ICN protocol is included in the control module 110 and thereby operates according to an exemplary embodiment of the present invention. The present invention is not limited to the example in which the ICN process 115 is present within the control module 110.

In the present exemplary embodiment, the ICN protocol refers to a transmission standard for transmitting and receiving information and is a request/response protocol between the ICN nodes 10. For example, when an ICN node A requests an ICN node B for information through the ICN protocol, the ICN node B transfers the requested information to the ICN node A in response to the request. The ICN protocol defines the following two packets.

An ICN information request packet refers to a packet transmitted from the ICN node 10 in order to request information and includes an identifier of the requested information. Also, the ICN information request packet may include an identifier of a source ICN node that has generated and initially transmitted the ICN information request packet.

An ICN information response packet refers to a response packet transmitted from the ICN node 10 having corresponding information as a response to the ICN information request packet. The requested information is included in a payload portion of the ICN information response packet, and the ICN information response packet includes an identifier of a source ICN node that has generated and initially transmitted the corresponding ICN information request packet.

The ICN information request packet has a function similar to a FIND message of a DONA and an INTEREST message of a CCN(Content-Centric Networking), and the ICN information response packet has a function similar to a DATA message of the CCN.

In the internal structure of the ICN node 10 based on the switch 100, the packet processors 122a and 122b belonging to the line cards 120a and 120b include a function of recognizing the header format of the received packet, and determining an output port via which to output the received packet. Accordingly, when the ICN information request packet or the ICN information response packet is received, the packet processors 122a and 122b serve to transfer a corresponding packet to the ICN process 115.

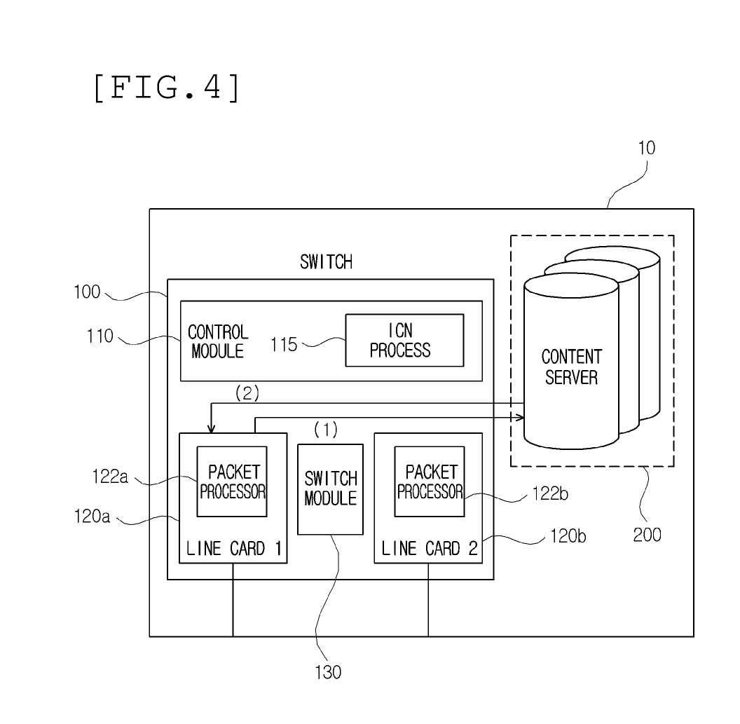

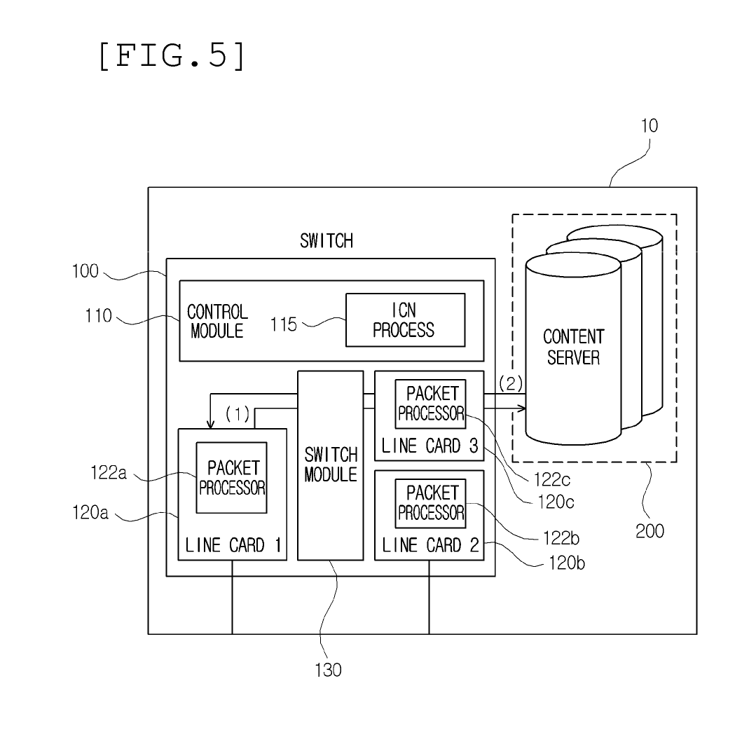

FIGS. 4 and 5 are diagrams illustrating a case in which the ICN node 10 based on the switch 100 directly provides information requested by a user instead of requesting another ICN node for the requested information. For example, the above case corresponds to a case in which the ICN node 10 stores information requested by the user.

FIG. 4 is a diagram illustrating a case in which the ICN node 10 based on the switch 100 closely combined with content servers provides content to the user, and illustrates a case in which the content servers are closely connected to the switch 100 and thereby may transmit and receive data without using a separate line card.

When the user uses a HyperText Transfer Protocol (HTTP) adaptive streaming service, a content request message of the user is an HTTP GET message. The ICN node 10 based on the switch 100 that receives the content request message of the user (1) determines one of the content servers managed by the ICN node 10 and transfers the content request message to the determined content server. (2) The determined content server provides corresponding content using a content response message as a response to the content request message. When the user uses the HTTP adaptive streaming service, the content response message is an HTTP 200 OK message.

FIG. 5 illustrates a structure in which a content server is connected to the switch 100 through a separate line card. FIG. 5 illustrates an exemplary embodiment in which the content server is connected to a line card (3) 120c. In FIG. 5, the line card (1) 120a receiving a content request message of a user transfers the content request message to the line card (3) 120c through the switch module 130, and the content server receives the content request message through the line card (3) 120c. A line card may be allocated to each content server, and the switch module 130 includes a function of determining an appropriate content server based on load states of content servers, and transmitting the content request message to a corresponding line card of the determined content server. In the following exemplary embodiment, the ICN node 10 based on the switch 100 that is closely combined with the switch 100 without using a separate line card is assumed.

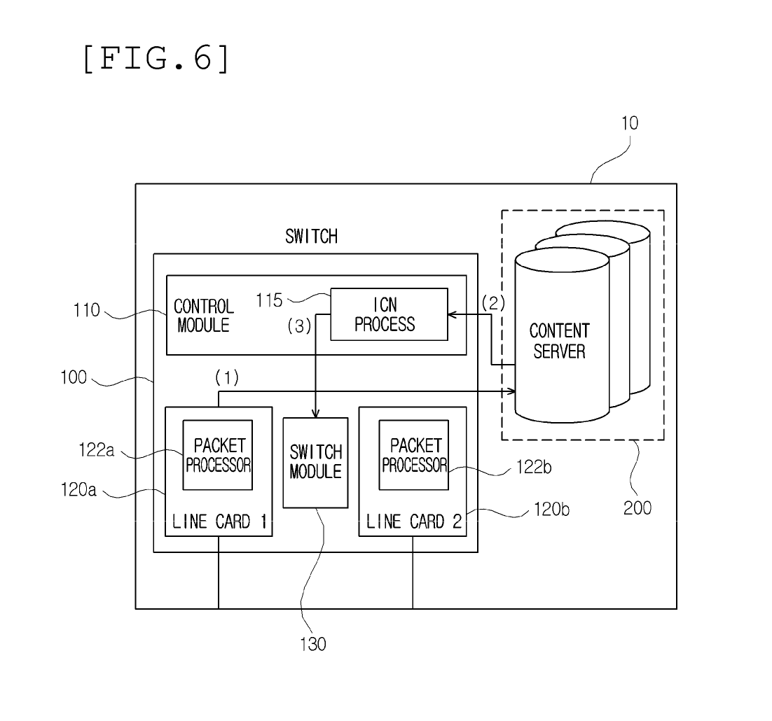

FIG. 6 is a diagram illustrating a case in which the ICN node 10 based on the switch 100 generates and initially transmits an ICN information request packet according to an exemplary embodiment of the present invention. For example, FIG. 6 is a diagram illustrating a case in which when the ICN node 10 based on the switch 100 does not directly provide the content requested by the user, the ICN node 10 requests another ICN node for the corresponding content through the ICN process 115.

As illustrated in FIG. 6, the ICN node 10 based on the switch 100 receives the content request message of the user. When the user uses an HTTP adaptive streaming service, the content request message is an HTTP GET message.

In the present exemplary embodiment, the line cards 120a and 120b receive the content request message of the user, and transfer the content request message to at least one content server managed by the ICN node 10.

A determined content server recognizes that the ICN node 10 to which the determined content server currently belongs to does not store the content specified in the content request message, and requests the ICN process 115 to obtain the content requested by the user. The ICN process 115 generates and then transmits an ICN information request packet in order to obtain the corresponding content.

Referring to FIG. 6, the ICN node 10 based on the switch 100 receiving the content request message of the user (1) determines one of content servers managed by the ICN node 10 and transfers the content request message to the determined content server. (2) The determined content server receiving the content request message recognizes that the content requested by the user is absent in the ICN node 10 to which the determined content server currently belongs to, and requests the ICN process 115 to obtain the corresponding content. (3) The ICN process 115 generates an ICN information request packet and transfers the ICN information request packet to the switch module 130 in order to transmit the ICN information request packet to another ICN node 10.

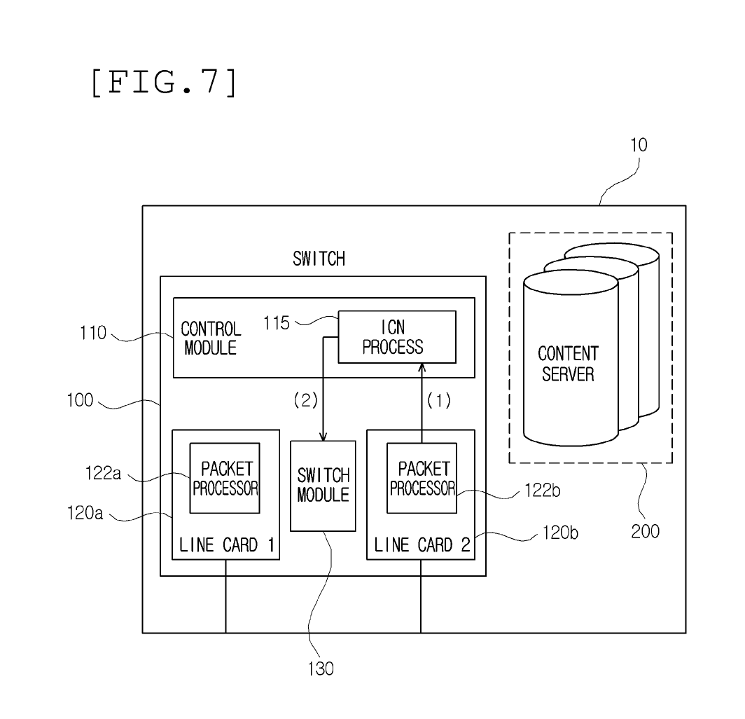

FIG. 7 is a diagram illustrating a case in which the ICN node 10 based on the switch 100 receives an ICN information request packet and an ICN information response packet according to an exemplary embodiment of the present invention.

FIG. 7 is an internal flowchart illustrating a case in which the ICN node 10 based on the switch 100 receives the ICN information request packet and the ICN information response packet.

The line cards 120a and 120b recognize that the received packet is the ICN information request packet or the ICN information response packet, and transfers the received packet to the ICN process 115. When the transferred packet is the ICN information response packet, the ICN process 115 verifies whether a source ICN node identifier included in the corresponding packet indicates the ICN process 115. When the transferred packet is the ICN information request packet, the ICN process 115 verifies whether information requested in the packet is stored.

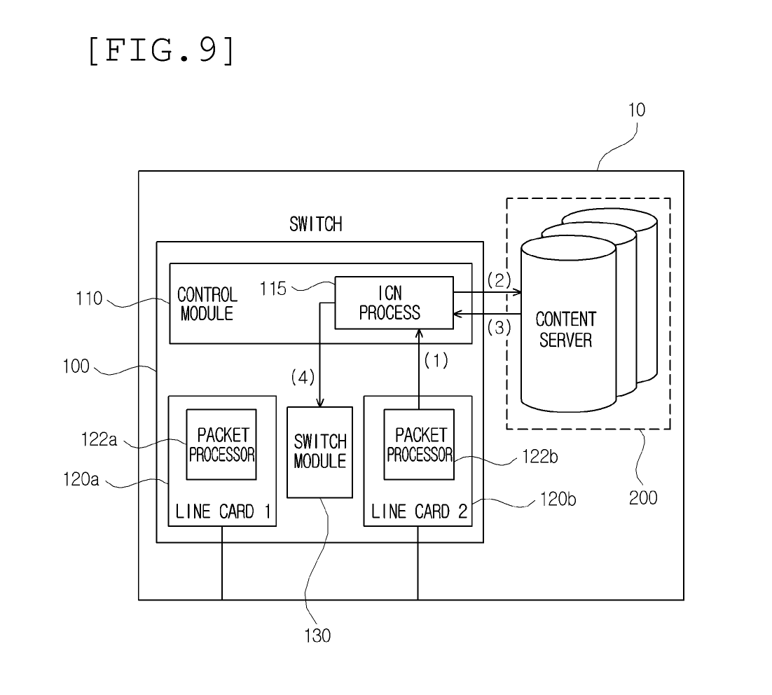

An exemplary embodiment in which the line card (2) 120b receives the ICN information request packet in FIG. 7 is described as follows. As illustrated in FIG. 7, (1) after receiving the ICN information request packet, the packet processor 122b transfers the corresponding packet to the ICN process 115. (2) The ICN process 115 verifies whether the ICN node 10 stores information requested in the transferred ICN information request packet. When the ICN node 10 does not store the corresponding information, the ICN process 115 determines another ICN node 10 to which the ICN information request is to be transferred and then transfers the ICN information request packet to the switch module 130 in order to transmit the ICN information request packet to the determined ICN node 10. When the ICN node 10 stores the corresponding information, a procedure of FIG. 9 will be followed.

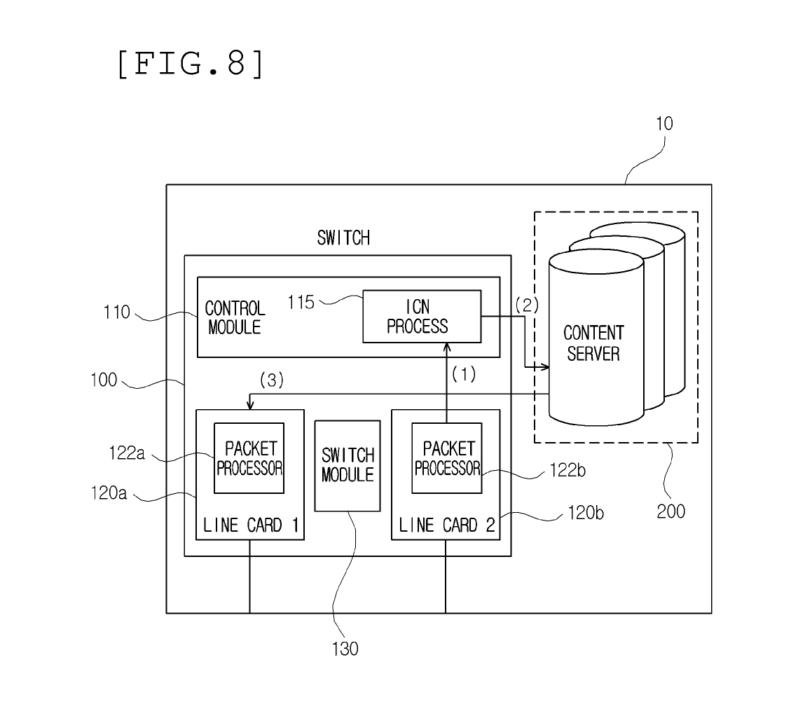

An exemplary embodiment in which the line card (2) 120b receives the ICN information response packet in FIG. 7 is described as follows. As illustrated in FIG. 7, (1) after receiving the ICN information response packet, the packet processor 122b transfers the corresponding packet to the ICN process 115. (2) The ICN process 115 verifies whether a source ICN node identifier included in the transferred ICN information response packet indicates the ICN process 115. When the source ICN node identifier does not indicate the ICN process 115, the ICN process 115 transfers the ICN information response packet to the switch module 130 in order to transmit the ICN information response packet to the source ICN node. When the source ICN node identifier indicates the ICN process 115, a procedure of FIG. 8 will be followed.

FIG. 8 is a diagram illustrating a case in which the ICN node 10 based on the switch 100 receives an ICN information response packet according to an exemplary embodiment of the present invention.

FIG. 8 is an internal flowchart illustrating a case in which the ICN node 10 based on the switch 100 receives the ICN information response packet to an ICN information request packet transmitted by the ICN node 10.

Referring to FIG. 8, (1) the line card (2) 120b of the ICN node 10 based on the switch 100 receives the ICN information response packet and then transfers the corresponding packet to the ICN process 115. (2) The ICN process 115 recognizes that the ICN information response packet is a response packet to the ICN information request packet transmitted by the ICN process 115 and transfers, to a content server, information included in a payload of the ICN information response packet. Here, the content server refers to a content server that requests the ICN process 115 to obtain content requested by the user in FIG. 6. (3) The content server provides the transferred information to the user.

FIG. 9 is a diagram illustrating a case in which the ICN node 10 based on the switch 100 receives an ICN information request packet according to an exemplary embodiment of the present invention.

FIG. 9 is an internal flowchart illustrating a case in which the ICN node 10 based on the switch 100 stores information requested in the ICN information request packet received by the ICN node 10.

Referring to FIG. 9, (1) the line card (2) 120b of the ICN node 10 based on the switch 100 receives the ICN information request packet and then transfers the corresponding packet to the ICN process 115. (2) The ICN process 115 requests at least one content server managed by the ICN node 10 for the corresponding information using an information identifier included in the ICN information request packet. (3) The content server transfers the requested information to the ICN process 115. (4) The ICN process 115 generates the ICN information response packet and transfers the corresponding packet to the switch module 130 in order to transmit information transferred from the content server. Here, the ICN information response packet includes an identifier of a source ICN node having generated and initially transmitted the received ICN information request packet.

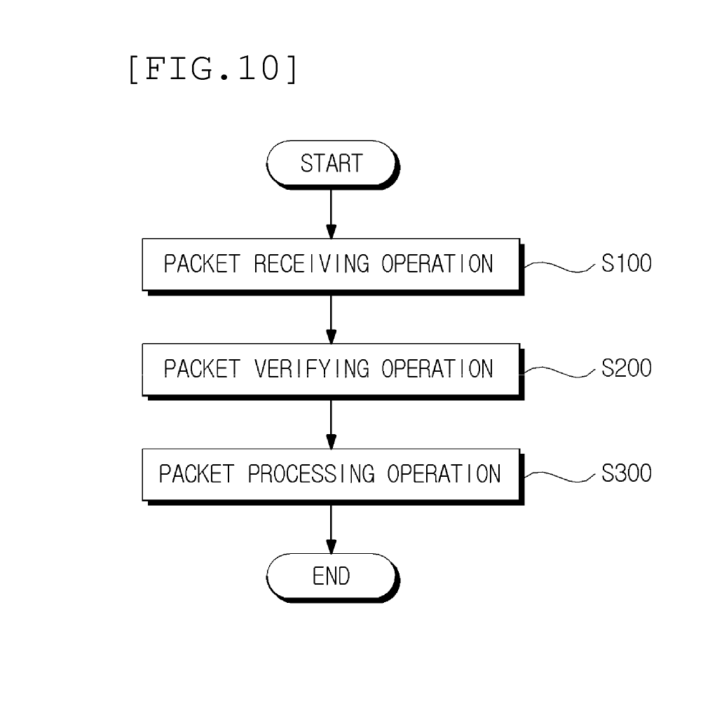

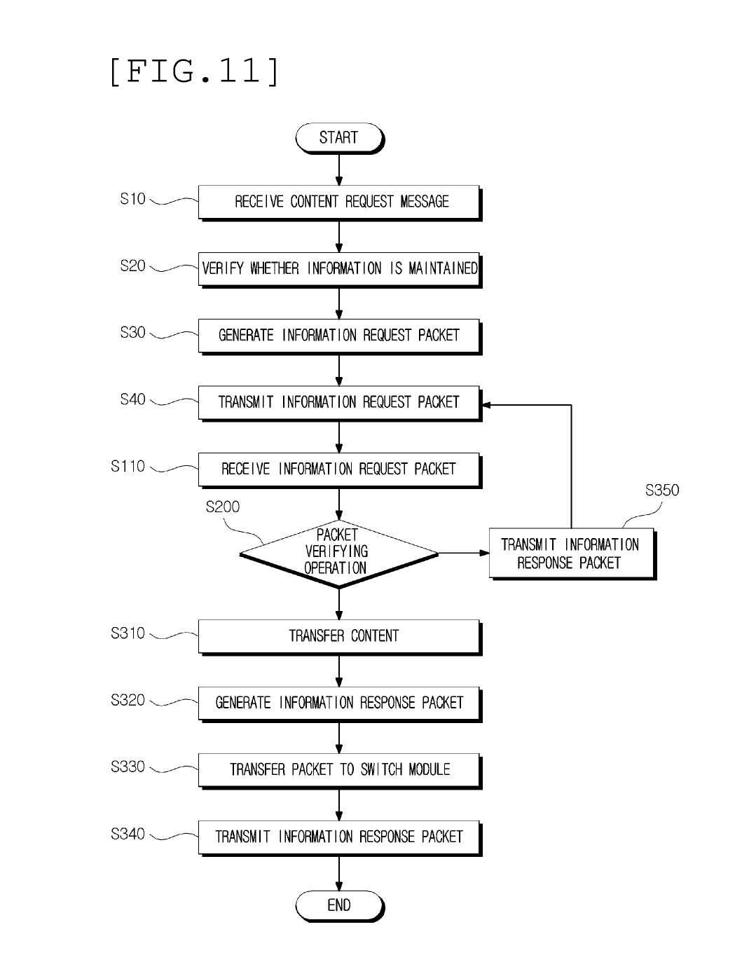

An ICN process based on a switch according to an exemplary embodiment of the present invention will be described with reference to FIGS. 10 and 11.

Referring to FIG. 10, the ICN process based on the switch according to the present exemplary embodiment includes a packet receiving operation 5100, a packet verifying operation 5200, and a packet processing operation S300.

The packet receiving operation 5100 receives an ICN information request packet and an ICN information response packet from line cards.

The packet verifying operation 5200 transfers the received packet to an ICN process. The ICN process verifies whether the corresponding packet indicates the ICN process when the transferred packet is the ICN information response packet, and verifies whether information requested in the packet is stored when the transferred packet is the ICN information request packet.

The packet processing operation 5300 processes the packet verified by the ICN process. In the present exemplary embodiment, the packet processing operation 5300 determines another ICN node to receive the verified packet and transfers the packet to a switch module.

Further, the ICN process according to the present exemplary embodiment receives a content request message prior to the packet receiving operation 5100, and verifies whether the content specified in the content request message is currently stored in a content server managed by the ICN node.

Further describing with reference to FIG. 11, the line cards receive the content request message requesting content of the user (S10), transfers the content request message to at least one content server, and thereby verifies whether the content specified in the content request message is stored (S20). The ICN process processes the content request message based on whether the content is stored.

The aforementioned message processing operation verifies whether the content is stored and thereby requests the ICN process for the content, generates an information request packet requesting information for the ICN process to request the content (S30) and transmits the information request packet (S40). Alternatively, the message processing operation verifies whether the content specified in the content request message is stored and thereby provides the content to the user or provides the content through the line cards.

Further, the line cards receive the information request packet (S110) and verify whether the information requested in the packet is stored through the ICN process (S200).

Next, when the information requested in the packet is verified not to be stored, the packet processing operation 5300 determines another ICN node to receive the verified packet and transfers the packet to a switch module (S350).

Also, when the information requested in the packet is stored, the packet processing operation 5300 receives the content requested in the verified information request packet from at least one content server managed by the ICN node (S310), generates an information response packet including the content (S320), determines the ICN node to receive the information response packet, and transfers the packet to the switch module (S330).

The switch module transfers the information response packet to the line cards, and transmits the information response packet to the ICN node having transmitted the information request packet (S340).

Further, when the information response packet is received in the packet receiving operation 5100, the packet processing operation 5300 transfers the content included in the verified information response packet to at least one content server managed by the ICN node, and thereby provides the content to the user through the content server.

A description relating to each operation is described in detail through each configuration of the aforementioned ICN node and thus, a repeated description will be omitted.

Meanwhile, the ICN process based on the switch of the present invention may be configured in a form of a computer-readable code in computer-readable media. The computer-readable media includes all the types of recording devices storing data readable by a computer system.

Examples of the computer-readable media may include ROM, RAM, CD-ROM, magnetic tapes, floppy disks, optical data storage devices, and the like. Also, the computer-readable media may be distributed over a computer system connected through a network and thereby a computer readable code using a distributive scheme may be stored and executed. Functional programs, codes, and code segments for realizing the present invention may be readily inferred by programmers in the art.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An information centric network (ICN) node based on a switch, the ICN node comprising:
an ICN process configured to process an ICN protocol for transferring content desired by a user;
a line card configured to transfer an receiving packet to the ICN process by parsing headers of the packet and, or output the received packet to determined output port; and
a switch module configured to relay the packet between line cards.

2. The ICN node of claim 1, wherein the ICN protocol includes an information request packet transmitted from the ICN node in order to request information and an information response packet transmitted from an ICN node that stores information requested in the information request packet.

3. The ICN node of claim 1, wherein:
the line card receives the information request packet or the information response packet and thereby transfer the received information request packet or information response packet to the ICN process, and
the ICN process verifies whether the transferred information request packet or information response packet is targeted to the ICN process or whether information requested in the information request packet is stored.

4. The ICN node of claim 3, wherein when the received information request packet or information response packet is not targeted to the ICN process or when information requested in the information request packet is not stored, the ICN process determines another ICN node to forward the received packet and transfers the received packet to the switch module.

5. The ICN node of claim 2, wherein the line card receives a content request message transmitted from the user in order to request content and transfers the content request message to at least one content server managed by the ICN node.

6. The ICN node of claim 5, wherein:
the content server verifies whether the content specified in the content request message is stored, and requests the ICN process for the content when the requested content is not stored, and
the ICN process generates an information request packet for requesting the content.

7. The ICN node of claim 5, wherein when the requested content is stored as a result of verifying whether the content specified in the content request message is stored, the content server provides the stored content to the user through the switch module, or directly provides the stored content to the user through a line card having received the content request message.

8. The ICN node of claim 3, wherein:
when information requested in the transferred information request packet is stored, the ICN process receives the content requested in the information request packet from at least one content server attached to and managed by the ICN node, and
generates an information response packet including the received content from the content server, determines an ICN node to forward the generated information response packet, and transfers the generated information response packet to the switch module.

9. The ICN node of claim 8, wherein the switch module transfers the information response packet to the line card and then line card transmits the information response packet to an ICN node having transmitted the information request packet.

10. The ICN node of claim 3, wherein the ICN process transfers content included in the verified information response packet to at least one content server managed by the ICN node.

11. An operation method of an ICN process based on a switch, the method comprising:
receiving, by a line card, an information request packet or an information response packet;
transferring, by the line card, the received packet to an ICN process, and verifying, by the ICN process, whether the received information request packet or information response packet is targeted to the ICN process or whether information requested in the information request packet is stored; and
processing, by the ICN process, the verified packet.

12. The method of claim 11, wherein the processing of the packet determines another ICN node to receive the verified packet and transfers the verified packet to a switch module.

13. The method of claim 11, before receiving the information request packet or the information response packet, further comprising:
receiving, by the line card, a content request message transmitted from a user in order to request content, transferring the content request message to at least one content server, and thereby verifying whether the content specified in the content request message is stored; and
processing the content request message based on whether the verified content is stored.

14. The method of claim 13, wherein the processing of the content request message verifies that the requested content is not stored and thereby requests the ICN process for the corresponding content, and the ICN process generates and transmits an information request packet for requesting the corresponding content.

15. The method of claim 13, wherein the processing of the content request message verifies that the content specified in the content request message is stored and thereby provides the corresponding content to the user through a switch module or directly provides the corresponding content through a line card having received the content request message.

16. The method of claim 11, wherein the processing of the packet receives content requested in the verified information request packet from at least one content server managed by the ICN node, generates an information response packet including the received content, determines an ICN node to forward the information response packet, and transfers the information response packet to a switch module.

17. The method of claim 16, wherein the switch module transfers the information response packet to a line card and then the line card transmits the information response packet to an ICN node having transmitted the information request packet.

18. The method of claim 11, wherein the processing of the packet transfers the content included in the verified information response packet to at least one content server managed by the ICN node.
